(19) United States
(12) Patent Application Publication
(10) Pub. No.: US 2005/0049166 A1
(43) Pub. Date: Mar. 3, 2005

(54) Enzyme-based cleaning composition and method of use

(76) Inventor: Tsao-Chin Clare Huang, Katy, TX (US)

Correspondence Address: Yukiko Iwata;Shell Oil Company, Legal - Intellectual Property, P.O. Box 2463, Houston, TX, 77252-2463, US

(21) Appl. No.: 10/923,420

(22) Filed: Aug. 20, 2004

Related U.S. Application Data
(60) Provisional application No. 60/498,758, filed on Aug. 29, 2003.

(51) Int. Cl. C11D 1/00

(52) U.S. Cl. 510/392

(57) ABSTRACT

Enzyme-based cleaning compositions for automobiles, bicycles and the like, is provided. The cleaning composition comprises an enzyme, a surfactant, at least one organic solvent and water. The cleaning composition can be used on the exterior as well as interior surfaces of automobiles.

The present application claims the benefit of pending U.S. Provisional Patent Application Ser. No. 60/498,758, filed Aug. 29, 2003, the entire disclosure is hereby incorporated by reference.

### FIELD OF THE INVENTION

The invention relates to enzyme-based cleaning compositions for automobiles, bicycles and the like.

### BACKGROUND OF THE INVENTION

Many different types of automobile cleaning agents are available for different cleaning purposes. The compositions of the various cleaning agents are adapted for use on the particular automobile surface to be cleaned and the type of soil to be removed. For example, petroleum distillates are commonly used to clean brake dust and road grime from wheels. Vinyl and rubber surfaces can be cleaned and preserved with polysiloxane-containing compositions. Car wash compositions typically comprise anionic detergents. The active ingredients of bug and tar removal compositions are typically petroleum distillates, xylene, benzene, or other hydrocarbon solvents. In other words, the majority of the automobile cleaning compositions are made up of harsh chemicals which can be harmful to the environment. In an era where health and environmental concerns are increasing, it is becoming more desirable to use effective cleaning compositions that are non-caustic and environmentally safe. Therefore, it is desirable to clean greasy substances without petroleum derived or halogenated hydrocarbon solvents or high levels of caustic chemicals and/or phosphates.

Enzymes are proteins synthesized by living organisms which can catalyze specific biochemical reactions such as the conversion of starch to sugar (amylase), the hydrolysis of fats to glycerol and fatty acids (lipase) and the hydrolytic breakdown of proteins (protease). The presence of an enzyme in a reaction lowers the activation energy of a particular reaction. The use of enzymes to remove soils and stains comprising proteins, carbohydrates and/or fats provides an alternate route for removing the soils and stains, because enzymes reduce the activation energy of the reaction and increase the reaction rate. In other words, the use of enzymes in combination with a surfactant package in a detergent would decompose substrate molecules within a stain faster than a surfactant alone. Enzyme formulations may be designed to remove various types of stains from soft surfaces such as cloth or leather and hard surfaces such as porcelain and metal. Thus, for example, proteases such as trypsin, pancreatin, papain and bromelain can be used in detergent formulations to remove proteinaceous stains. Specific glycosidases such as cellulase, lysozyme, amylase and glucanase, on the other hand, can be formulated with various detergents for removal of certain carbohydrate stains. Other detergent formulations containing lipases may be use to remove stains such as greases and oils.

Therefore, there is a need for an enzyme-based cleaning composition that can be used on the exterior as well as interior surfaces of automobiles. Preferably, the compositions are non-toxic, non-flammable, non-volatile, odorless and environmentally friendly.

### SUMMARY OF THE INVENTION

In one aspect, the invention relates to a liquid cleaning composition comprising a surfactant, an enzyme, at least one solvent organic solvent and, water, wherein the composition is suitable for cleaning the interior and exterior surface of an automobile. In another aspect, the invention relates to a method of cleaning an automobile comprising contacting the interior or exterior surface of an automobile with a liquid enzyme composition comprising a water base and containing at least one enzyme dissolved in said water base, a surfactant and at least one organic solvent.

Additional aspects of the invention, advantages and characteristics provided by various embodiments of the invention are apparent to those skilled in the art with the following description.

### DESCRIPTION OF EMBODIMENTS OF THE INVENTION

It has been found that the above-mentioned need can be met by using a cleaning composition comprising one or more enzymes. In certain embodiments of the invention, the cleaning compositions of the invention further comprise one or more cleaning composition materials compatible with the enzyme. The term “cleaning composition materials”, as used herein, means any liquid, solid or gaseous material selected for the particular type of cleaning composition desired and the form of the product (e.g., liquid; granule; spray composition), which materials are also compatible with the protease enzyme used in the composition. The specific selection of cleaning composition materials are readily made by considering the surface, item or fabric to be cleaned, and the desired form of the composition for the cleaning conditions during use (e.g., through the wash detergent use). The term “compatible”, as used herein, means the cleaning composition materials do not reduce the proteolytic activity of the protease enzyme to such an extent that the protease is not effective as desired during normal use situations.

There are several technical challenge that need to be addressed in the preparation of an enzyme-based cleaning composition. Some enzymes under certain conditions can become airborne and cause allergy effects on consumers. The dry dust and dry enzyme molecules could become allergen, especially in a closed confined environment. These allergy effects usually build up gradually in the human body. These allergens will irritate mucous membranes and cause allergic reactions. In order to prevent this occurrence, it is necessary to develop low allergenic technical enzyme packages. Another solution is to develop the detergent/cleaning package that the enzymes can be rinsed, wiped off, or vacuumed properly and carefully after the product accomplishes the task so that the enzymes will not become solid powders. Foams might be a good option for this purpose because they are easy to wipe off.

Enzymes in general are unstable relative to man-made catalysts but technology has been developed to improve the stability. There is a concern that some enzymes will be inactivated by a spray type of product delivery system. The spray motion might cause phase separation and the enzyme will be denatured. Liquid detergent formulations containing enzymes for laundry application have been known to have problems relating to the instability of the enzyme due to decomposition caused either by surfactant denaturation or by self-digestion (proteolysis). It has been an issue to stabilize enzymes over extended periods of time, particularly when they are exposed to heat which further reduces enzyme stability. When they are used in car care formulations, it is important to keep in mind that enzymes have to be stabilized so that the enhanced and/or synergistic cleaning effects will be achieved. Alternatively, bacteria in some applications can be used to solve the allergy and stability problems. Bacteria are microorganisms which produce the aforementioned enzymes. Compared to using enzymes, the advantages of using bacteria are (1) good stability; and (2) will not cause allergy effects on human simply because the bacteria are not going to be an airborne system. Just like enzymes, bacteria are typically incorporated into detergent packages as supplements to surfactants and other chemicals in the detergent package to provide additional cleaning efficiency toward protein, fat oil, blood, grease, starch, and sugar. In its stable inactive (just like plant seed being inactive) bacteria form, called “spore”, it offers a longer shelf life than the enzymes.

As used herein, the term “enzyme composition” is a composition that comprises an enzyme. Enzymes are a group of proteins which catalyze a variety of typically biochemical reactions. Enzyme preparations have been obtained from natural sources and have been adapted for a variety of chemical applications. Enzymes are typically classified based on the substrate target of the enzymatic action. The enzymes useful in the compositions involve hydrolases and oxidoreductases. Hydrolases are enzymes that attack complex molecules, accelerating their digestion and yielding simpler substances. Since this process of digestion is referred to as hydrolysis, the enzymes that catalyze the process are considered to be “hydrolyzing enzymes” or “hydrolases”.

The “hydrolase” group of enzymes comprises: (1) Amylases, which catalyze the digestion of starch into small segments of multiple sugars and into individual soluble sugars, and may be used to remove saccharidic substances such as french fries or foods containing starch, such as beans, potatoes, and rice, by hydrolysis, for removal of tea stains and for industrial usage in the area of starchy soil removal; (2) Proteases, (or proteinase), which split up proteins into their component amino acid building blocks and may be used to remove proteinaceous substances and stains; (3) Lipases, which split up animal and vegetable fats and oils into their component part: glycerol and fatty acids, and may be used to remove the lipids present in foods like oily stains, fatty acids or animal fats including those types of tough stains difficult to remove such as gravy and grease stains; industrial usage like greasy soil removal and can further be used to remove bug spots on car hood and body panels; (4) Cellulase (of various types) which breaks down the complex molecule of cellulose into smaller components of single and multiple sugars; (5) Beta-glucanase, (or gumase) which digest one type of vegetable gum into sugars and/or dextrins; and (6) Pectinase, which digests pectin and similar carbohydrates of plant origin.

Oxidoreductases are enzymes that catalyze electron transfer in oxidation-reduction reactions. Oxidoreductases are classified into several groups according to their respective donors or acceptors. Examples of oxidoreductases include, but are not limited to, oxidoreductases that act on the CH—OH group of donors; oxidoreductases that act on the aldehyde or oxo group of donors; oxidoreductases that act on the CH—CH group of donors; oxidoreductases that act on the CH—NH2 group of donors; oxidoreductases that act on the CH—NH group of donors; oxidoreductases that act on NADH or NADPH; oxidoreductases that act on other nitrogenous compounds as donors; oxidoreductases that act on a sulfur group of donors; oxidoreductases that act on heme group of donors; oxidoreductases that act on diphenols and related substances as donors; oxidoreductases that act on a peroxide as acceptor; oxidoreductases that act on hydrogen as donor; oxidoreductases that act on single donors with incorporation of molecular oxygen (oxygenases); oxidoreductases that act on paired donors with incorporation of molecular oxygen; oxidoreductases that act on superoxide radicals as acceptor; oxidoreductases that oxidize metal ions; oxidoreductases that act on —CH2— groups; oxidoreductases that act on reduced ferredoxin as donor; oxidoreductases that act on reduced flavodoxin as donor; and, other oxidoreductases. An example of a suitable oxidoreductase which may be used in an embodiment of the invention is laccase. Under the reactions employed in embodiments of the invention, laccase displays great robustness with minimum strength loss.

An embodiment of the invention employs an enzyme composition comprising one or more hydrolases. In another embodiment of the invention, the enzyme composition comprises only one hydrolase. In certain embodiments of the invention the enzyme compositions comprise cellulose hydrolases (cellulases). In other embodiments of the invention, the enzyme composition comprises pectases (pectinesterases). Certain embodiments of the invention employ an enzyme composition comprising a combination of cellulase and pectase. Certain embodiments of the invention employ a combination of a hydrolase and an oxidoreductase.

Cellulases are typically produced from bacterial and fungal sources which use cellulase in the degradation of cellulose to obtain an energy source or to obtain a source of structure during their life cycle. Examples of bacteria and fungi which produce cellulase are as follows: Bacillus hydrolyticus, Cellulobacillus mucosus, cellulobacillus myxogenes, Cellulomonas sp., Cellvibrio fulvus, Celluvibrio vulgaris, Clostridium thermocellulaseum, Clostridium thermocellum, Corynebacterium sp., Cytophaga globulosa, Pseudomonas fluoroescens var. cellulosa, Pseudomonas solanacearum, Bacterioides succinogenes, Ruminococcus albus, Ruminococcus flavefaciens, Sorandium composition, Butyrivibrio, Clostridium sp., Xanthomonas cyamopsidis, Sclerotium bataticola, Bacillus sp., Thermoactinomyces sp., Actinobifida sp., Actinomycetes sp., Streptomyces sp., Arthrobotrys superba, Aspergillus aureus, Aspergillus flavipes, Aspergillus flavus, Aspergillus fumigatus, Aspergillus fuchuenis, Aspergillus nidulans, Aspergillus niger, Aspergillus oryzae, Aspergillus rugulosus, Aspergillus sojae, Aspergillus sydwi, Aspergillus tamaril, Aspergillus terreus, Aspergillus unguis, Aspergillus ustus, Takamine-Cellulase, Aspergillus saitoi, Botrytis cinerea, Botryodipiodia theobromae, Cladosporium cucummerinum, Cladosporium herbarum, Coccospora agricola, Curvuiaria lunata, Chaetomium thermophile var. coprophile, Chaetomium thermophile var. dissitum, Sporotrichum thermophile, Taromyces amersonii, Thermoascus aurantiacus, Humicola grisea var. thermoidea, Humicola insolens, Malbranchea puichella var. sulfurea, Myriococcum albomyces, Stilbella thermophile, Torula thermophila, Chaetomium globosum, Dictyostelium discoideum, Fusarium sp., Fusarium bulbigenum, Fusarium equiseti, Fusarium lateritium, Fusarium lini, Fusarium oxysporum, Fusarium vasinfectum, Fusarium dimerum, Fusarium japonicum, Fusarium scirpi, Fusarium solani, Fusarium moniliforme, Fusarium roseum, Helminthosporium sp., Memnoniella echinata, Humicola fucoatra, Humicola grisea, Monilia sitophila, Monotospora brevis, Mucor pusillus, Mycosphaerella citrulina, Myrothecium verrcaria, Papulaspore sp., Penicillium sp., Penicillium capsulatum, Penicillium chrysogenum, Penicillium frequentana, Penicillium funicilosum, Penicillium janthinellum, Penicillium luteum, Penicillium piscarium, Penicillium soppi, Penicillium spinulosum, Penicillium turbaturn, Penicillium digitatum, Penicillium expansum, Penicillium pusitlum, Penicillium rubrum, Penicillium wortmanii, Penicillium variabile, Pestalotia palmarum, Pestalotiopsis westerdijkii, Phoma sp., Schizophyllum commune, Scopulariopsis brevicaulis, Rhizopus sp., Sporotricum carnis, Sporotricum pruinosum, Stachybotrys atra, Torula sp., Trichoderma viride (reesei), Trichurus cylindricus, Verticillium albo atrum, Aspergillus cellulosae, Penicillium glaucum, Cunninghamella sp., Mucor mucedo, Rhyzopus chinensis, Coremiella sp., Karlingia rosea, Phytophthora cactorum, Phytophthora citricola, Phytophtora parasitica, Pythium sp., Saprolegniaceae, Ceratocystis ulmi, Chaetomium globosum, Chaetomium indicum, Neurospora crassa, Sclerotium rolfsii, Aspergillus sp., Chrysosporium lignorum, Penicillium notatum, Pyricularia oryzae, Collybia veltipes, Coprinus sclerotigenus, Hydnum henningsii, Irpex lacteus, Polyporus sulphreus, Polyporus betreus, Polystictus hirfutus, Trametes vitata, Irpex consolus, Lentines lepideus, Poria vaporaria, Fornes pinicola, Lenzites styracina, Merulius lacrimans, Polyporus palstris, Polyporus annosus, Polyporus versicolor, Polystictus sanguineus, Poris vailantii, Puccinia graminis, Tricholome fumosum, Tricholome nudum, Trametes sanguinea, Polyporus schweinitzil FR., Conidiophora carebella, Cellulase AP (Amano Pharmaceutical Co., Ltd.), Cellulosin AP (Ueda Chemical Co., Ltd.), Cellulosin AC (Ueda Chemical Co., Ltd.), Cellulase-Onozuka (Kinki Yakult Seizo Co., Ltd.), Pancellase (Kinki Yakult Seizo Co., Ltd.), Macerozyme (Kinki Yakult Seizo Co., Ltd.), Meicelase (Meiji Selka Kaisha, Ltd.), Celluzyme (Nagase Co., Ltd.), Soluble sclase (Sankyo Co., Ltd.), Sanzyme (Sankyo Co., Ltd.), Cellulase A-12-C (Takeda Chemical Industries, Ltd.), Toyo-Cellulase (Toyo Jozo Co., Ltd.), Driserase (Kyowa Hakko Kogyo Co., Ltd.), Luizyme (Luipold Werk), Takamine-Cellulase (Chemische Fabrik), Wallerstein-Cellulase (Sigma Chemicals), Cellulase Type I (Sigma Chemicals), Cellulase Serva (Serva Laboratory), Cellulase 36 (Rohm and Haas), Miles Cellulase 4,000 (Miles), R & H Cellulase 35, 36, 38 conc (Phillip Morris), Combizym (Nysco Laboratory), Cellulase (Makor Chemicals), Celluclast, Celluzyme, Cellucrust (NOVO Industry), and Cellulase (Gist-Brocades). Cellulase preparations are available from Accurate Chemical & Scientific Corp., Alltech, Inc., Amano International Enzyme, Boehringer Mannheim Corp., Calbiochem Biochems, Carolina Biol. Supply Co., Chem. Dynamics Corp., Enzyme Development, Div. Biddle Sawyer, Fluka Chem. Corp., Miles Laboratories, Inc., Novo Industrials (Biolabs), Plenum Diagnostics, Sigma Chem. Co., United States Biochem. Corp., and Weinstein Nutritional Products, Inc.

Cellulase, like many enzyme preparations, is typically produced in an impure state and often is manufactured on a support. The solid cellulase particulate product is provided with information indicating the number of international enzyme units present per each gram of material. The activity of the solid material is used to formulate the treatment compositions of this invention. Typically the commercial preparations contain from about 1,000 to 6,000 CMC (carboxymethyl cellulose) enzyme units per gram of product.

Pectin polymers are important constituents of plant cell walls. Pectin is a hetero-polysaccharide with a backbone composed of alternating homogalacturonan (smooth regions) and rhamnogalacturonan (hairy regions). The smooth regions are linear polymers of 1,4-linked alpha-D-galacturonic acid. The galacturonic acid residues can be methyl-esterified on the carboxyl group to a varying degree, usually in a non-random fashion with blocks of polygalacturonic acid being completely methyl-esterified.

Pectinases can be classified according to their preferential substrate, highly methyl-esterified pectin or low methyl-esterified pectin and polygalacturonic acid (pectate), and their reaction mechanism, beta-elimination or hydrolysis. Pectinases can be mainly endo-acting, cutting the polymer at random sites within the chain to give a mixture of oligomers, or they may be exo-acting, attacking from one end of the polymer and producing monomers or dimers. Several pectinase activities acting on the smooth regions of pectin are included in the classification of enzymes provided by the Enzyme Nomenclature (1992) such as pectate lyase (EC 4.2.2.2), pectin lyase (EC 4.2.2.10), polygalacturonase (EC 3.2.1.15), exo-polygalacturonase (EC 3.2.1.67), exo-polygalacturonate lyase (EC 4.2.2.9) and exo-poly-alpha-galacturonosidase (EC 3.2.1.82).

Pectate lyases have been cloned from different bacterial genera such as Erwinia, Pseudomonas, Klebsiella and Xanthomonas. Also from Bacillus subtilis (Nasser et al. (1993) FEBS 335:319-326) and Bacillus sp. YA-14 (Kim et al. (1994) Biosci. Biotech. Biochem. 58:947-949) cloning of a pectate lyase has been described. Purification of pectate lyases with maximum activity in the pH range of 8-10 produced by Bacillus pumilus (Dave and Vaughn (1971) J. Bacteriol. 108:166-174), B. polymyxa (Nagel and Vaughn (1961) Arch. Biochem. Biophys. 93:344-352), B. stearothermophilus (Karbassi and Vaughn (1980) Can. J. Microbiol. 26:377-384), Bacillus sp. (Hasegawa and Nagel (1966) J. Food Sci. 31:838-845) and Bacillus sp. RK9 (Kelly and Fogarty (1978) Can. J. Microbiol. 24:1164-1172) has been reported, however, no publication was found on cloning of pectate lyase encoding genes from these organisms. All the pectate lyases described require divalent cations for maximum activity, calcium ions being the most stimulatory.

Any pectinesterase from plants, bacteria or fungi, suitable for the degradation of pectin can be used in embodiments of the invention. Preferably, the pectinesterase is from fungal origin. More preferably, the pectinesterase is to obtained from Aspergilli, especially preferred is the use of pectinesterase obtained from Aspergillus niger.

In a preferred embodiment purified pectinesterase is used. This purification can be performed in different ways.

The crude enzyme may be purified for example by liquid chromatography (ion exchange, gel filtration, affinity) or by selective inhibition of the pectin depolymerases (pH shock, heat shock, chemical inhibitors, chemical or organic solvents extraction; see U.S. Pat. No. 2,599,531, which is fully incorporated by reference herein). Another source for obtaining purified pectinesterase as defined for the application is pectinesterase obtained by recombinant DNA technology. An example of the use of recombinant DNA technology is the expression cloning of the Aspergillus niger pectinesterase. As expression host Aspergillus niger could be used. However, in view of the possible contamination of the pectinesterase with polygalacturonase, pectin lyase and other pectin depolymerases it may be preferable to use a heterologous host organism for producing the pectinesterase. Suitable host organisms include bacteria and fungi. Preferred species are Bacilli, Escherichia, Saccharomyces, Kluyveromyces and Aspergilli.

A embodiment of the invention discloses a cleaning composition comprising one or more enzymes and one or more surfactants. As used herein, the term “surfactants” encompasses cationic, anionic and nonionic surfactants.

The nonionic surfactants present in the invention will preferably have a pour point of less than 40° C., more preferably less than 35° C., and most preferably below about 30° C. They will have an HLB (hydrophile-lipophile balance) of between 2 and 16, more preferably between 4 and 15, and most preferably between 10 and 14. However, mixtures of lower HLB surfactants with higher HLB surfactants can be present, the resulting HLB usually being an average of the two or more surfactants. Additionally, the pour points of the mixtures can be, but are not necessarily, weighted averages of the surfactants used. The nonionic surfactants are preferably selected from the group consisting of C₆₋₁₈ alcohols with 1-15 moles of ethylene oxide per mole of alcohol, C₆₋₁₈ alcohols with 1-10 moles of propylene oxide per mole of alcohol, C₆₋₁₈ alcohols with 1-15 moles of ethylene oxide and 1-10 moles of propylene oxide per mole of alcohol, C₆₋₁₈ alkylphenols with 1-15 moles of ethylene oxide or propylene oxide or both, and mixtures of any of the foregoing. Certain suitable surfactants are available from Shell Chemical Company under the trademark Neodol. Suitable surfactants include Neodol 25-9 (C₁₂₋₁₅ alcohol with an average 9 moles of ethylene oxide per mole of alcohol). Another suitable surfactant may be Alfonic 1218-70, which is a C₁₂₋₁₈ alcohol, which is ethoxylated with about 10.7 moles of ethylene oxide per mole of alcohol, from Vista Chemical, Inc. These and other nonionic surfactants used in the invention can be either linear or branched, or primary or secondary alcohols. If surfactants used are partially unsaturated, they can vary from C₁₀₋₂₂ alkoxylated alcohols, with a minimum iodine value of at least 40, such as exemplified by Drozd et al., U.S. Pat. No. 4,668,423, incorporated herein by reference. An example of an ethoxylated, propoxylated alcohol is Surfonic JL-80X (C₉₋₁₁ alcohol with about 9 moles of ethylene oxide and 1.5 moles of propylene oxide per mole of alcohol), available from Texaco Chemical Company.

Other suitable nonionic surfactants may include polyoxyethylene carboxylic acid esters, fatty acid glycerol esters, fatty acid and ethoxylated fatty acid alkanolamides, certain block copolymers of propylene oxide and ethylene oxide and block polymers of propylene oxide and ethylene oxide with a propoxylated ethylene diamine (or some other suitable initiator). Still further, such semi-polar nonionic surfactants as amine oxides, phosphine oxides, sulfoxides and their ethoxylated derivatives, may be suitable for use herein.

Nonionic surfactants are especially preferred for use in this invention since they are generally found in liquid form, usually contain 100% active content, and are particularly effective at removing oily soils, such as sebum and glycerides. The nonionic surfactant should be present in the liquid detergent at about 5-65%, more preferably 15-45%, and most preferably 25-40%, by weight of the composition. It is actually most preferred to have the surfactant system include about at least 50% nonionic surfactant. The ratio of the surfactants should be, preferably, about 10:1 to 1:1, nonionic to anionic surfactants, more preferably 4:1 to 1:1. The resulting liquid composition should preferably have a viscosity of about 1-5,000 centipoises (CPS), more preferably 5-3,000 CPS, and most preferably about 10-1,500 CPS.

The anionic surfactants used in certain embodiments of the invention are selected from the group consisting of alkylphosphate, ammonium polyoxyethylene (POE) alkyl aryl ether sulfates, sodium dodecyl sulfate, sodium bis-2-ethylhexylsulfosuccinate, sodium dioctyl sulfosuccinate and sodium dodecylbenzene sulfonate.

The enzyme composition of the invention is generally a water solution containing a mixture of enzymes, including protease and one or more other enzymes, such as amylase, cellulase, lipase, peptinase and urease.

Specific examples of proteases that can be used are fungal prozyme 60,000 protease units/gram, fungal amano A 20,000 protease units/gram, acid stable 7,000 protease units/gram, bacterial neutral 12,000 protease units/gram, and papain 300-1200 MC units/gram.

Specific examples of amylases that can be used are bacterial amylase 17,000 bacterial amylase units/gram, bacterial amylase 175,000 bacterial amylase units/gram, fungal amylase and bacterial amylase 28,000,000 BAU/gm.

Specific examples of cellulases that can be used are cellulase AEI at 20,000 CMCase units/gram, Cellulase AIE 40,000 CMCase units/gram, cellulase AIE at 60,000 CMCase units/gram, cellulase AIE at 160,000 CMCase units/gram, cellulase trichoderma viride 20,000 CMCase units/gram, cellulase trichoderma viride 40,000 CMCase units/gram, cellulase trichoderma viride 60,000 CMCase units/gram, cellulase trichoderma viride 160,000 CMCase units/gram.

Specific examples of lipases that can be used are candida cylindracae lipase AP 60,000 units/gram and lipase aspergillis niger AP 10,000 units/gram.

Specific examples of peptinases that can be used are as follows: trypsin alphachymotrypsin chymotrypsin, pepsin, ficin and bromolain 1,800 to 2,000 GD u/gm from porcine pancrease, Mexican Ficus Carica sap, Ananas Comosos stems and leaves.

Specific examples of uriase, uricase, or urikinase, 1,500 to 800,000 u/gm from chickasaw beans, jack beans, bacillus pasteruii, porcine liver or candida utilis.

The concentration or amount of the various enzymes used in the water solution is not critical and varying concentrations can be used depending on the nature of the material to be cleaned. The maximum concentration of the enzymes is limited by saturation of the solution and cost.

To prevent the digestive effect of the protease on the other enzymes in the solution, the composition contains a benzamidine hydrohalide, preferably benzamidine hydrochloride. The benzamidine hydrochloride is employed in a minimum concentration of 0.003 molar solution and preferably in a molar solution of 0.003 to 0.006. The exact mechanism by which the benzamidine hydrochloride inhibits the digestive effect of the protease system is not completely understood, but it is believed that the benzamidine hydrochloride will lock up or isolate the protease docking sites to render the protease inactive against the other enzymes.

At the time of use, the composition is diluted with additional water to reduce the concentration of the benzamidine hydrochloride to a value less than 0.003 molar solution, thereby releasing the inhibitory effect and enabling the protease to retain its digestive effect against proteinaceous stains and materials.

The enzyme composition is preferably prepared in two phases. In the first phase the benzamidine hydrohalide is added to water, along with a small amount of a buffering salt, such as monosodium phosphate, to obtain a pH in the range of about 5.0 to 7.0. Following this, the enzymes are added to the solution with the protease normally being added first so that the benzamidine hydrohalide will deactivate the protease.

The composition is then mixed with a high shear mixer for a period of about 20 to 30 minutes and filtered through a 1 micron filter to remove bacteria and cellular debris. A second phase is produced by adding a polyol, such as propylene glycol, glycerol or sorbitol, to water. The polyol is used to enhance the activity of the benzamidine hydrohalide.

To this second phase solution is added a non-ionic preservative for the enzyme, such as isoctyl phenoldodecylethoxylate, nonylphenoldecylethoxylate, alpha dodecanoldecylethoxylate, or alpha dodecanoldodecylethoxlate.

In addition, a bacteriastat, such as propylparahydroxy benzoate or methylparahydroxy benzoate, can be included in the second phase solution, along with a material, such as sodium thiosulfite, which acts as a heavy metal scavenger. If desired, a dye and fragrance can also be added to the second phase. The second phase solution is mixed for a period of 20 to 30 minutes and then the two solutions are blended together, refiltered and bottled.

The enzyme composition in accordance with embodiments of the invention can be used in a wide variety of cleaning applications.

In an embodiment of the invention, the cleaning composition comprises one or more solvents. Preferably the solvent is a lower alkanol, i.e., a C₁₋₄ alcohol, is used in the invention to enhance the dispersibility of the composition and possibly, to thin a relatively viscous formulation. Ethanol and propanol are preferred, with ethanol being most preferred. 0-25% of the alkanol is present, more preferably 1-20%, and most preferably 1-15%.

A further solvent may also be substituted for the alkanol, or combined with the alkanol, and added to the invention. These are selected from C₂₋₆ glycols and glycol ethers. Examples of such glycols include ethylene glycol and propylene glycol, and an exemplary glycol ether is 2-butoxyethanol (also called butyl Cellosolve, available from Union Carbide). If both solvents, i.e., alkanol and either glycol or glycol ether, are present, it is preferred that they be in a ratio of about 10:1 to 1:10, more preferably about 3:1 to 1:3, and most preferably about 1:1. Propylene glycol is especially preferred, because of the added phase stability it produces, as well as enhanced rinsability of the liquid detergent.

In some embodiments, a liquid cleaning composition comprises a surfactant, an enzyme, at least one organic solvent and, water, wherein said composition is suitable for cleaning the interior and exterior surface of an automobile. In other embodiments, one or more of the components like surfactant and organic solvent are excluded.

Certain embodiments of the invention further comprise a phase stabilizer selected from water soluble chlorides, formates, acetates and propionates. In certain embodiments, the organic solvent is selected from the group consisting of alcohols, alkylene glycols and glycol ethers. In other embodiments, the enzyme is selected from the group consisting of proteases, amylases, cellulases, lipases and mixtures thereof.

The liquid cleaning compositions may further comprising an adjunct selected from the group consisting of dyes, pigments, fluorescent whitening agents, anti-redeposition agents, anti-foaming agents, buffers, liquid peroxygen bleaches, bleach activators, thickeners, fragrances, and mixtures thereof, or surfactants selected from the group consisting of anionic, cationic or nonionic surfactants.

In an embodiment, the invention recites a method of cleaning an automobile comprising contacting the interior or exterior surface of an automobile with a liquid enzyme composition comprising a water base and containing one or enzymes dissolved in said water base, a surfactant and at least one organic solvent.

Without limiting the scope of the invention, specific examples of cleaning compositions are provided below:

(1) Bug Spot Cleaner:

The product incorporates lipases and proteases into an anionic-surfactant based car wash/cleaning packages to wipe off and clean up bug spots on body panels, such as engine hoods, windshields, windows, mirrors, bumpers, and windshield wipers. Bug spots are usually not easy to wash by strong soaps and it is natural that these bugs should be wiped off and cleaned effectively by enzymes. It is also advantageous to develop the Enzyme Package which has enzyme component as mixtures selected from the group consisting of proteases, amylases, lipases, cellulases, and peroxidases to cover a variety of performance claims, such as soils, leaf sap, tree resins, tree fluids, proteinaceous substances, oily stains, grease stains, fats, and saccharidic substances.

(2) Tree Resin and Leaf Sap Cleaner:

The product incorporates amylases and proteases into an anionic surfactant based car wash/cleaning package to wipe off and clean up tree resin spots, leaf sap spots, sugar based resin stains, and tree liquid spots on body panels, such as engine hoods, windshields, windows, mirrors, bumpers, and windshield wipers. It is also advantageous to develop an enzyme package where the enzyme component is a mixture selected from the group consisting of proteases, amylases, lipases, cellulases, and peroxidases to cover a variety of performance claims, such as bug spots, soils, leaf sap, tree resins, tree fluids, proteinaceous substances, oily stains, grease stains, fats, and saccharidic substances.

(3) Car Interior Cleaning Product—Carpet, Upholstery, Seating, Cushions, and Fabrics

The product incorporates mainly proteases, lipases, and amylases into surfactant based car interior cleaning packages to clean up grease spots, blood spots, coke stains, tea stains, and all kind of food stains, soils, leaf sap, proteinaceous substances, oily stains, fats, gravy stains, and saccharidic substances from carpet, upholstery, seating, cushions and fabrics.

(4) Recreation Vehicle and Bus Toilet Cleaning Product:

The product incorporates mainly proteases, lipases, and amylases into surfactant based detergent/cleaning products for recreation vehicles and buses specifically to clean up toilet equipment.

### EXAMPLE

Bug and Grill Cleaner:

A composition which can be used to clean bug debris from the grill of an automobile is described below. The composition comprises an 8% solution of an enzyme-surfactant blend and a 15% solution of a degreaser. The composition further comprises 3-5% of citrus terpene d-limonene, nonionic enzymes and oxyranic polymers comprising 0-1% hydrophobic alkyl alcohols and 0-1% carbonyl compounds for use as emulsifying agents.

A non-water based composition comprising substantially the same components as the above composition, has also been formulated and tested for its cleaning ability.

As demonstrated above, embodiments of the invention provide an automotive cleaning composition and a method for cleaning the exterior and interior of an automobile. Embodiments of the invention may have one or more of the following advantages:

(1) Low cost and high performance component in the cleaning/detergent package;

(2) Can be used to enhance and to gain a synergistic effect in cleaning power or detergency;

(3) Can replace organic solvent type of cleaning agents—to solve the problems in toxicity, flammability, and VOC, and also other health hazard problems, including those associated with volatility and odor. Recent volatile organic compound (VOC) regulations have driven the formulation of various products including automotive products to reduce the use of traditional solvents and low molecular weight chemical surfactants. This has limited the effectiveness in several areas and presents a commercial opportunity to provide an effective cleaning product within the VOC regulations;

(4) In comparison to a cleaning package that contains only surfactant, enzymes speed up the breaking down of different waste, stains, and spots in a shorter time frame. These substrates include proteins, juice, vegetable oil, fatty acids, animal fats, gravy, grease, blood, french fries, beans, potatoes, and rice stains or spots;

(5) An environmentally friendly solution to the car care and detergent/cleaning products;

(6) Offers a solution for certain substrates that are difficult to be cleaned up by soaps or other detergents such as the bug spots; or,

(7) Enzymes can be used as the optical brightener in various detergent systems, these characteristics might be used to make the car care product more attractive.

While the invention has been described with respect to a limited number of embodiments, the specific features of one embodiment should not be attributed to other embodiments of the invention. No single embodiment is representative of all aspects of the inventions. In some embodiments, the compositions may include numerous compounds not mentioned herein. In other embodiments, the compositions do not include, or are substantially free of, any compounds not enumerated herein. Variations and modifications from the described embodiments exist. The method is described as comprising a number of acts or steps. These steps or acts may be practiced in any sequence or order unless otherwise indicated. Finally, any number disclosed herein should be construed to mean approximate, regardless of whether the word “about” or “approximately” is used in describing the number. The appended claims intend to cover all those modifications and variations as falling within the scope of the invention.

1. A liquid cleaning composition comprising:
a) a surfactant;
b) an enzyme;
c) at least one organic solvent; and,
d) water,
wherein said composition is suitable for cleaning the interior and exterior surface of an automobile.

2. The liquid cleaning composition of claim 1 wherein the enzyme is hydrolases or oxidoreductases.

3. The liquid cleaning composition of claim 1 further comprising a phase stabilizer selected from water soluble chlorides, formates, acetates and propionates.

4. The liquid cleaning composition of claim 1 wherein the solvent is selected from the group consisting of alcohols, alkylene glycols and glycol ethers.

5. The liquid cleaning composition of claim 1 wherein said enzyme is selected from the group consisting of proteases, amylases, cellulases, beta-glucanases, pectinases, pectinesterase, lipases and mixtures thereof.

6. The liquid cleaning composition of claim 1 further comprising at least one detergent adjunct selected from the group consisting of dyes, pigments, fluorescent whitening agents, anti-redeposition agents, anti-foaming agents, buffers, liquid peroxygen bleaches, bleach activators, thickeners, fragrances, and mixtures thereof.

7. The liquid cleaning composition of claim 1 wherein the surfactant is selected from the group consisting of anionic, cationic and nonionic surfactants.

8. The liquid cleaning composition of claim 4 wherein said solvent is ethanol, propanol, butyl alcohol or a mixture thereof.

9. The liquid cleaning composition of claim 2 wherein the surfactant is selected from the group consisting of anionic, cationic or nonionic surfactants.

10. A method of cleaning an automobile comprising contacting the interior or exterior surface of an automobile with a liquid enzyme composition comprising a water base, at least one enzyme dissolved in said water base, a surfactant and at least one organic solvent.

11. The method of claim 10 wherein the liquid enzyme composition further comprises a phase stabilizer selected from water soluble chlorides, formates, acetates and propionates.

12. The method of claim 10 wherein the solvent is selected from the group consisting of alcohols, alkylene glycols and glycol ethers.

13. The method of claim 10 wherein the enzyme is selected from the group consisting of proteases, amylases, cellulases, beta-glucanases, pectinases, pectinesterase, lipases and mixtures thereof.

14. The method of claim 10 wherein the liquid enzyme composition further comprises at least one additive selected from the group consisting of dyes, pigments, fluorescent whitening agents, anti-redeposition agents, anti-foaming agents, buffers, liquid peroxygen bleaches, bleach activators, thickeners, fragrances, and mixtures thereof.

15. The method of claim 10 wherein the surfactant is selected from the group consisting of anionic, cationic or nonionic surfactants.

16. The method of claim 12 wherein the solvent is ethanol, propanol, butyl alcohol or a mixture thereof.

17. The method of claim 10 wherein the enzyme is hydrolases or oxidoreductases.

18. The method of claim 17 where the surfactant is selected from the group consisting of anionic, cationic and nonionic surfactants.
